(19) United States
(12) Patent Application Publication
(10) Pub. No.: US 2015/0169526 A1
(43) Pub. Date: Jun. 18, 2015

(54) HEURISTICALLY DETERMINING KEY EBOOK TERMS FOR PRESENTATION OF ADDITIONAL INFORMATION RELATED THERETO

(71) Applicant: Kobo Incorporated, Toronto (CA)

(72) Inventors: Sameer HASAN, Toronto (CA); Inmar-Ella GIVONI, Toronto (CA)

(73) Assignee: Kobo Incorporated, Toronto (CA)

(21) Appl. No.: 14/133,503

(22) Filed: Dec. 18, 2013

(51) Int. Cl. G06F 17/24; G06F 17/22; G06F 17/30

(52) U.S. Cl. CPC G06F 17/241; G06F 17/30864; G06F 17/2235

(57) ABSTRACT

Systems and methods for rendering automatic annotation for electronic books with external information provided by an information database. Key terms in an ebook are automatically selected for annotation based on a record of search events in which users submitted query terms concerning the ebook in search for relevant external information on Internet. The query terms may be submitted by users through ebook graphical user interfaces (GUIs) and/or web browsers rendered on terminal devices. Search events occurred on individual terminal devices can be recorded and then supplied to a server device which can aggregate such information based on some population of readers of the ebook. The most frequently searched query terms may be automatically selected for annotating the ebook.

### CROSSREFERENCES

The present disclosure is related to: the commonly assigned and co-pending U.S. patent application titled “DETERMINING KEY EBOOK TERMS FOR PRESENTATION OF ADDITIONAL INFORMATION RELATED THERETO,” U.S. patent application Ser. No. 13/924,339, filed on Jun. 21, 2013; the commonly assigned and co-pending U.S. patent application titled “PRESENTING EXTERNAL INFORMATION RELATED TO PRESELECTED TERMS IN EBOOK,” U.S. patent application Ser. No. 13/964,739, and filed on Aug. 12, 2013; and the commonly assigned and co-pending U.S. patent application titled “PRESENTING AN AGGREGATION OF ANNOTATED TERMS IN EBOOK,” U.S. patent application Ser. No. 13/964,791, and filed on Aug. 12, 2013. The foregoing patent applications are incorporated by reference herein.

### TECHNICAL FIELD

The present disclosure relates generally to the field of electronic text, e.g., electronic books, and, more specifically, to the field of computerized annotation of electronic text.

### BACKGROUND

When reading an electronic or conventional book, a reader often encounters interesting or strange terms that he or she wants to have more knowledge about, in addition to what the book itself presents. Mostly likely, the knowledge is readily available on the Internet. For example, online encyclopedia databases, such as Wikipedia, are popular resources that contain a very large amount of well-organized information that covers almost every conceivable subject matter. Conventionally, the reader can find a computing device connected to the Internet, open an internet browser to visit Wikipedia, and then submit his or her search term to get the relevant information on the book term. However, the reader may find this process cumbersome and interruptive and may give up the intention for a deep dive experience.

To facilitate book readers' deep dive experience, certain terms can be automatically selected from an ebook and automatically associated with annotation information. When a user reading the ebook interacts with the pre-selected term, the corresponding annotation information can be quickly retrieved and presented to the user immediately. Existing efforts of identifying or selecting key terms from an electronic text for annotation are typically based on an estimation of interest categories, such as people, places, organizations and similar categories, as well as a theoretical analysis of the content of the electronic text. For example, terms with high usage frequencies in a selected library and high specificity to the context of the ebook are considered “relevant” or interesting,” and thus are selected for such annotation.

However, such key terms are usually limited to certain categories and may not match well with a general readers' interests in the real word. For example, popular and interesting subjects to the public vary after the electronic text is published, which are difficult to predict through a theoretical analysis approach.

### SUMMARY OF THE INVENTION

It would be advantageous to provide a mechanism of automatically identifying key terms for annotation from an ebook that more closely reflect a user's real world interests for a deep dive experience.

Accordingly, an embodiment of the present disclosure employs a computer implemented method of heuristically determining key terms mentioned in an ebook for annotation based on a record of search events related to the ebook. In the search events, users submit query terms concerning the ebook in search for relevant external information on the Internet. The query terms may be submitted by users through book reading graphical user interfaces (GUIs) and/or web browsers rendered on electronic reader devices. Search events occurring on individual terminal devices can be recorded and then supplied to a server device which can aggregate such information based on some population of readers of the ebook. The most frequently searched query terms may be automatically selected for annotating the ebook.

Through data mining and disambiguation processes, relevant external information for each key term can then be automatically discovered by electronically exploring information source sites. Hyperlinks can be embedded in the terms in the ebook. Consequently, once a user of the ebook selects such a term through a book reading GUI, the corresponding external information can be displayed directly and promptly on an electronic reader through a network connection. Because the key terms identified using a heuristic can offer a high probability of matching a real life average user's interest for the deep dive experience, convenient access to the expanded information of these key terms can effectively improve the users' book reading experience on the ebook.

In one embodiment of present disclosure, a computer implemented method of annotating an electronic book comprises: (1) accessing statistical information related to a collection of search query terms submitted by users concerning the ebook, the collection of search query terms submitted to one or more search engines; (2) automatically identifying a first plurality of annotation terms from the collection of search query terms based on the statistical information in accordance with a predetermined criterion; (3) automatically associating relevant external information with the first plurality of annotation terms; and (4) associating the relevant external information and the first plurality of annotations terms with the ebook.

The statistical information may comprise a query frequency corresponding to each of the collection of search query terms relative to a number of users accessing the ebook. The predetermined criterion may comprise a query frequency threshold corresponding to the ebook on display devices. The collection of search query terms may include search query terms submitted through a search field in an ebook graphical user interface (GUI) rendering the ebook, and a plurality of search query terms submitted through a web browser. Further, a search query term may also be submitted by a user selecting the term in line with the book text, and then choosing to look up, for example, on Google or Wikipedia.

The method may also comprise: (1) accessing an information source site, the information source site comprising a plurality of webpages, each webpage associated with a subject title; (2) accessing content of the ebook; and (3) automatically identifying a second plurality of annotation terms of the ebook based on the content of the ebook and based on subject titles of the plurality of webpages. The automatically associating may comprise: (1) accessing an information source site, the information source site comprising a plurality of webpages, each webpage associated with a subject title; (2) matching each annotation term of the first plurality of annotation terms to a respective webpage of the information source site, wherein the respective webpage comprises the relevant external information of the annotation term; and (3) establishing a hyperlink between the annotation terms with the respective webpage of the information source site.

In another embodiment of present disclosure, a non-transitory computer-readable storage medium embodying instructions that, when executed by a processing device, cause the processing device to perform a method of automatically identifying key terms from an electronic text for annotation. The method comprises: (1) accessing a record of search events related to the electronic text, wherein the record comprises search terms submitted in the search events by users accessing the electronic text to one or more search engines, wherein the electronic text comprises the search terms; and (2) automatically identifying a first plurality of key terms for annotation from the search terms based on statistical information with respect to the search terms in accordance with a predetermined criterion, wherein the statistical information is derived from the record.

In another embodiment of present disclosure, a system comprises: a processor; and a memory coupled to the processor and comprising instructions that, when executed by the processor, causes the processor to perform a method of automatically determining annotation terms from an ebook for annotation. The method comprises: (1) accessing statistical information related to a collection of search query terms submitted by users of the ebook to one or more search engines; (2) automatically identifying a first plurality of annotation terms from the collection of search query terms based on the statistical information in accordance with a predetermined criterion; and (3) associating the relevant external information and the first plurality of annotations terms with the ebook.

This summary contains, by necessity, simplifications, generalizations and omissions of detail; consequently, those skilled in the art will appreciate that the summary is illustrative only and is not intended to be in any way limiting. Other aspects, inventive features, and advantages of the present invention, as defined solely by the claims, will become apparent in the non-limiting detailed description set forth below.

### BRIEF DESCRIPTION OF THE DRAWINGS

Embodiments of the present invention will be better understood from a reading of the following detailed description, taken in conjunction with the accompanying drawing figures in which like reference characters designate like elements and in which:

FIG. 1 is a flow chart illustrating an exemplary computer implemented method of heuristically identifying key terms related to an ebook for annotation in accordance with an embodiment of the present disclosure.

FIG. 2 illustrates an exemplary system that can facilitate a user to obtain external information on preselected terms in an annotated ebook or a passage thereof through an electronic reader in accordance with an embodiment of the present disclosure.

FIG. 3 is a flow chart depicting an exemplary computer implemented method of rendering an annotation GUI for a preselected term in an ebook in accordance with an embodiment of the present disclosure.

FIG. 4 illustrates an exemplary on-screen book reading GUI 401 comprising a key term and an exemplary annotation GUI generated in accordance with an embodiment of the present disclosure.

FIG. 5 is a block diagram illustrating an exemplary computing system including an ebook annotation generator in accordance with an embodiment of the present disclosure.

### DETAILED DESCRIPTION

Reference will now be made in detail to the preferred embodiments of the present invention, examples of which are illustrated in the accompanying drawings. While the invention will be described in conjunction with the preferred embodiments, it will be understood that they are not intended to limit the invention to these embodiments. On the contrary, the invention is intended to cover alternatives, modifications and equivalents, which may be included within the spirit and scope of the invention as defined by the appended claims. Furthermore, in the following detailed description of embodiments of the present invention, numerous specific details are set forth in order to provide a thorough understanding of the present invention. However, it will be recognized by one of ordinary skill in the art that the present invention may be practiced without these specific details. In other instances, well-known methods, procedures, components, and circuits have not been described in detail so as not to unnecessarily obscure aspects of the embodiments of the present invention. The drawings showing embodiments of the invention are semi-diagrammatic and not to scale and, particularly, some of the dimensions are for the clarity of presentation and are shown exaggerated in the drawing Figures. Similarly, although the views in the drawings for the ease of description generally show similar orientations, this depiction in the Figures is arbitrary for the most part. Generally, the invention can be operated in any orientation.

### NOTATION AND NOMENCLATURE

It should be borne in mind, however, that all of these and similar terms are to be associated with the appropriate physical quantities and are merely convenient labels applied to these quantities. Unless specifically stated otherwise as apparent from the following discussions, it is appreciated that throughout the present invention, discussions utilizing terms such as “processing” or “accessing” or “executing” or “storing” or “rendering” or the like, refer to the action and processes of a computer system, or similar electronic computing device, that manipulates and transforms data represented as physical (electronic) quantities within the computer system's registers and memories and other computer readable media into other data similarly represented as physical quantities within the computer system memories or registers or other such information storage, transmission or display devices. When a component appears in several embodiments, the use of the same reference numeral signifies that the component is the same component as illustrated in the original embodiment.

### Heuristically Determining Key Ebook Terms for Presentation of Additional Information Related Thereto

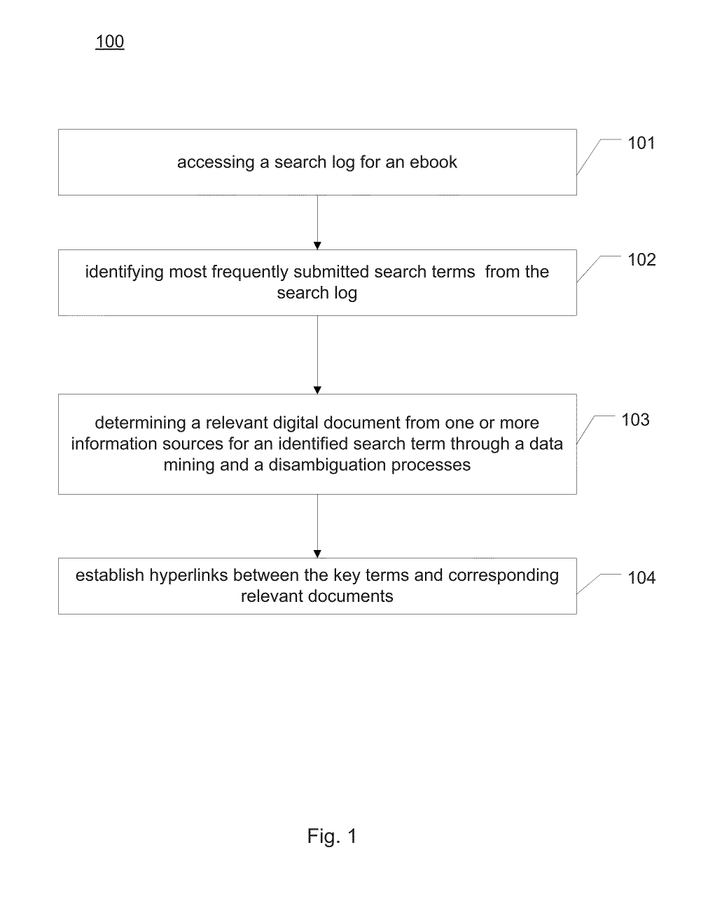

FIG. 1 is a flow chart illustrating an exemplary computer implemented method 100 of heuristically identifying key terms related to an ebook for annotation in accordance with an embodiment of the present disclosure. Method 100 may be implemented as a software program in a server or client device for instance. At 101, a search log that records a plurality of search events, or search activities, related to the ebook is accessed. In a search event that occurs on a book reader device for example, a user submits a query term mentioned in the ebook to one or more search engines. The searching process can yield information relevant to the query term that is retrieved from external information source sites, e.g., Wikipedia or a digital dictionary stored on the book reader device. The query terms may comprise any type of expression recognizable by a computer, such as a word, a phrase, a symbol, etc.

A search query term can be submitted through a search field embedded in an ebook GUI of a book reading program that renders the ebook. In some embodiment, the book reading program is also capable of logging the search event, e.g., via the operating system, when a user exits the ebook and engages a web browser to find additional information concerning a word that is present in the ebook. In some embodiments, a search conducted through a web browser may be linked to an ebook if the search event occurs while the ebook is being presented or shortly after the user exits the ebook.

Information related to the search events may be initially recorded in respective local reader devices and then provided to the server device through the network. With respect to each search event, the recorded information may include the event time, the search query term, the search engines used, the information source site selected, and the relevant information selected for display, etc. The server device may maintain a search log specific to the ebook that aggregates the recorded information.

At 102, key terms for annotation can be automatically selected based on the statistics derived from the search log in accordance with a predetermined criterion. In some embodiments, the statistics correspond to the total occurrences of search events for each query term relative to the population of the book readers, which is indicative of an average user's tendency to gain external knowledge about the term through Internet. The predetermined criterion may correspond to a threshold for the total occurrences or for the rank of the total occurrences, etc. Thereby, the most popular query terms can be identified as key terms for annotation.

In some embodiments, relevant statistical information derived from a search log can also be used to select a search engine, an information source site, and content of the external information to be presented for a query term.

In some embodiments, the key terms selected for annotation can be determined solely on a heuristics basis according to an embodiment of the present disclosure. However, any other suitable method of identifying key terms can be combined to annotate an ebook. In some embodiments, a selection of key terms can be extracted from an ebook based on analyses on the content and context of the ebook in accordance with the prior art, e.g., through a term frequency—inverse document frequency (TF-IDF)-based content analysis. Additional key terms can be identified after an aggregation of search events related to the ebook have been observed and processed in accordance with the present disclosure. The additional key terms can then be added to update the ebook.

After a key term is selected for annotation as described above, a matching digital document can be discovered by exploring one or more external information source site through a data mining process and a possible disambiguation processes for multi-sensed terms at 103. Any suitable database server may act as an information source to provide pertinent annotation for selected terms in accordance with the present disclosure. Also, any suitable method can be used to retrieve information from an information source for purposes of practicing the present disclosure. More than one information source accessible to a public reader can be used to provide annotation for an electronic book by virtue of network connections, e.g. WAN, LAN, or WiFi.

At 104, after the key terms are mapped to the respective matching documents from one or more source sites, the documents are associated with the key terms, for example, by use of hyperlinks embedded with the terms. It will be appreciated that the selected terms are non-language-specific can be associated with external information represented in any language.

In some embodiments, method 100 can be executed periodically to automatically update the selection of key terms for annotation as well as to update the annotation information associated therewith, e.g., to incorporate the updated entries of the information sites. A set of key terms can be updated by adding new terms or removing terms from the set.

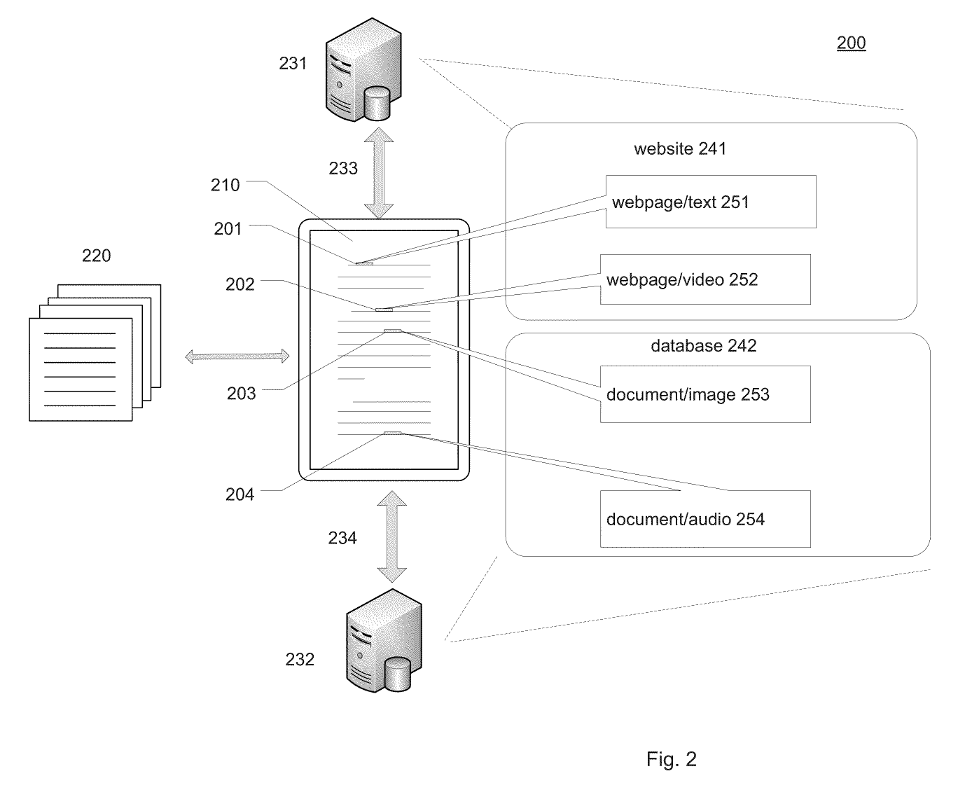

FIG. 2 illustrates an exemplary system that can facilitate a user to obtain external information on preselected terms in an annotated ebook 220 or a passage thereof through an electronic reader 210 in accordance with an embodiment of the present disclosure. The annotated ebook 220 comprises annotations on the plurality of automatically preselected terms, or annotated terms, with hyperlinks embedded therein. The annotated terms include the key terms determined heuristically as described with reference to FIG. 1, which have been proved to be interesting to a significant number of users.

The annotated ebook 220 can be stored in a storage device of the electronic reader 210 and its content can be displayed on the display panel. As illustrated, the present displayed ebook page 220 comprises discernible marks that identify four annotated terms 201-204. When the user selects an annotated term by a suitable input means, the embedded hyperlink associated with the annotated term can lead to the matching document hosted by the specific information database. The matching document or a portion thereof containing information related to the annotated term can then be presented on-screen to the user through the electronic reader 210 quickly without requiring the user personally entering an information website and submitting an inquiry. Therefore, the reader can advantageously take the shortcut to acquire additional information related to a preselected term. The present disclosure is not limited by any particular manner of presenting the related information to a user on an electronic reader.

A variety of devices run electronic book reader software such as personal computers, handheld personal digital assistants (PDAs), cellular phones with displays, and so forth.

In the illustrated example, webpages 251 and 252 from an information website 241 hosted by the server 231 are used to annotate terms 201 and 202. To name a few examples, the information website 241 can be any well known information source, such as Wikipedia, Baidu, Canadian Encyclopedia, Credo Reference, EcuRed, or Grolier Multimedia Encyclopedia, etc. Whereas, documents 253 and 254 stored in a local database server 242 are more pertinent to terms 203 and 204 and therefore are used to provide annotation to these two terms respectively. The information sources may contain image, video, or audio content, in addition to text-related content that are presentable on an electronic device.

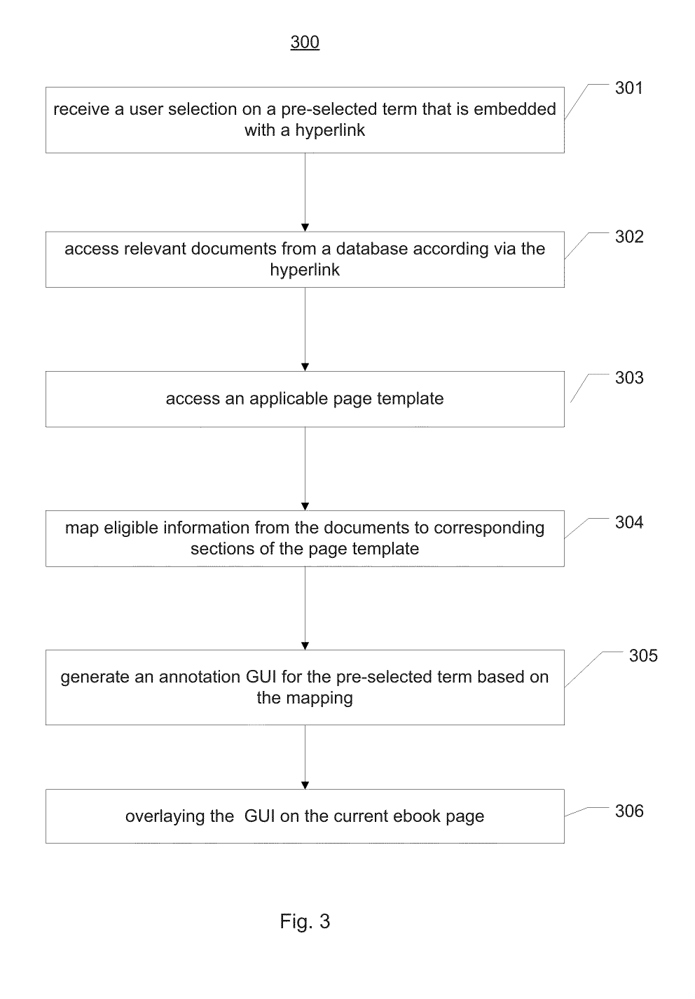

FIG. 3 is a flow chart depicting an exemplary computer implemented method 300 of rendering an annotation GUI for a preselected term in an ebook in accordance with an embodiment of the present disclosure. At 301, an electronic reader device receives a user interaction with a preselected term that is embedded with a hyperlink. The preselected term may be encompassed in an overview GUI, a term summary GUI, or a book reading GUI for instance.

At 302, through the hyperlink, an external document including relevant information hosted by a database is accessed in any suitable mechanism. At 303, an applicable annotation page template, e.g., a wireframe, can be accessed to process the external document. In some embodiments, the page template may be generic with respect to all types of terms. In some other embodiments, specific page templates with different fields and layouts may be available for different types of terms, such as symbols, persons, places, themes, and concepts. In this case, a matching page template is first determined to process the external document.

At 304, eligible information from the documents are selected and mapped to corresponding sections of the page template in accordance with respective field identifications attached to the page template and the documents. At 305, an annotation GUI is generated for the selected term based on the mapping. At 306, the annotation GUI is displayed on the electronic device, e.g., overlaying a portion of current GUI.

The computer implemented method can be used in a variety of devices running an ebook-rendering software, such as desktop computer, a laptop computers, handheld personal digital assistants (PDAs), a tablet, a smart phones with displays, and so forth.

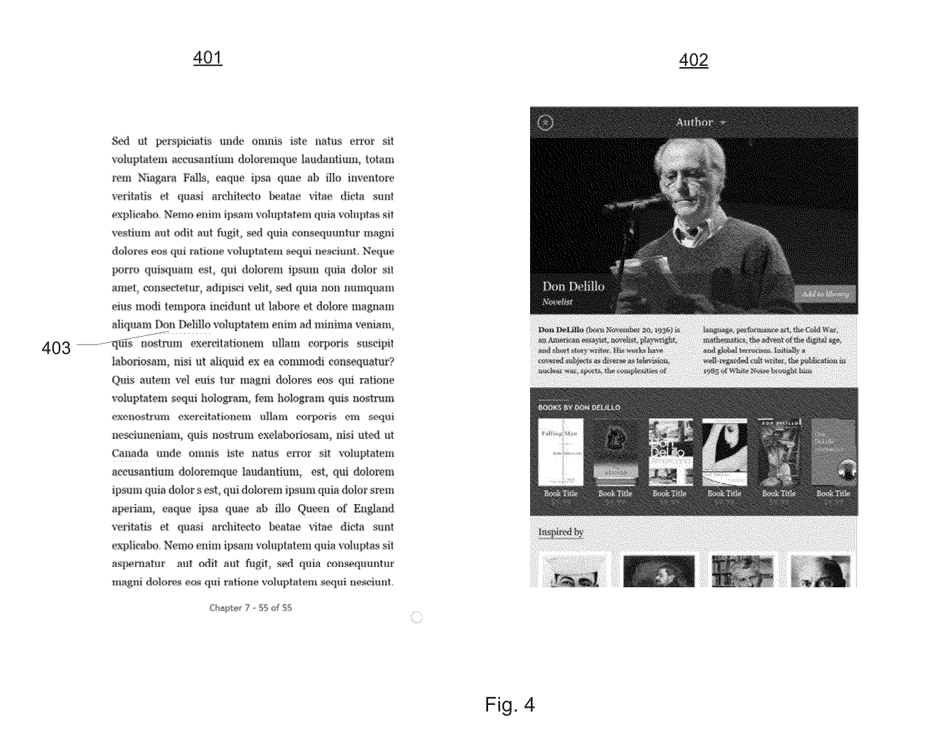

FIG. 4 illustrates an exemplary on-screen book reading GUI 401 comprising a key term 403 and an exemplary annotation GUI 402 generated in accordance with an embodiment of the present disclosure. The annotation GUI 402 may be generated based on a wireframe. The book reading GUI 401 contains an underlined term “Don Delillo” 403 which is automatically selected for annotation heuristically. Upon user's selection of the term 403, the annotation GUI 402 can be displayed with information derived from a related Wikipedia page in a format defined by the corresponding wireframe. The annotation GUI 402 includes an image, a description of Don Delillo's life, books related to Don Delillo's, his biography, related information including genres and instruments, quotations including websites, and articles.

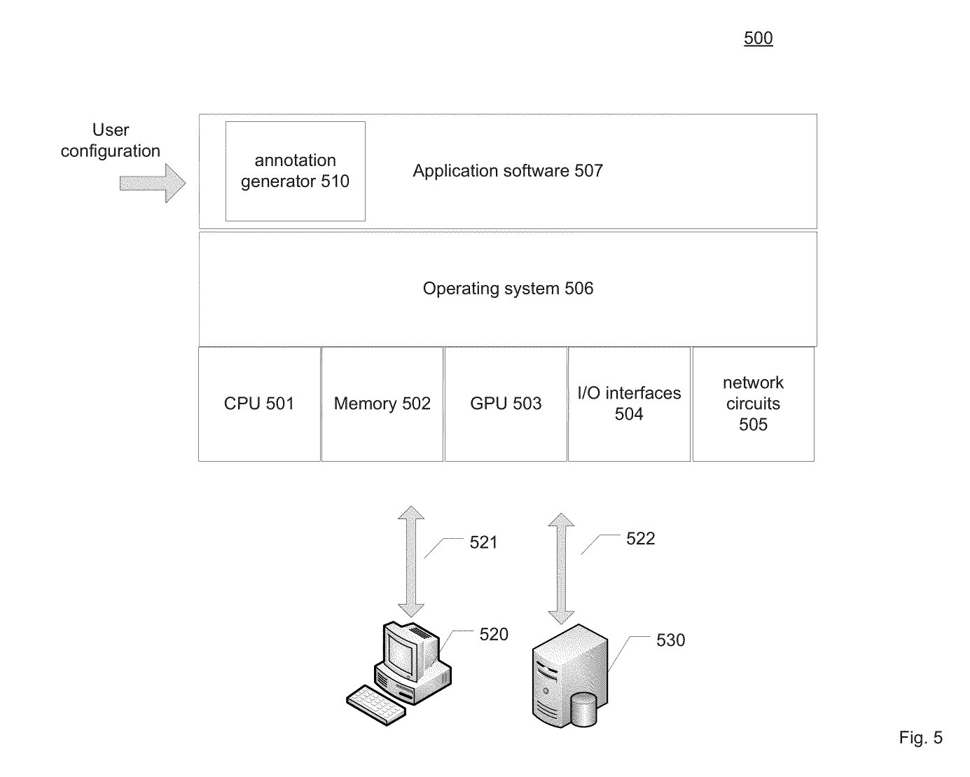

FIG. 5 is a block diagram illustrating an exemplary computing system 500 including an ebook annotation generator 510 in accordance with an embodiment of the present disclosure. The computing system 500 comprises a processor 501, a system memory 502, a GPU 503, I/O interfaces 504 and network circuits 505, an operating system 506 and application software 507 including the annotation generator 510 stored in the memory 502. The computing system 500 may corresponds to a server system hosted by an on-line book store for example. System 500 can communicate with the client device 520 remotely through the network channel 521 to collect data of search events on ebooks. System 500 also communicates with an information source server 430, e.g., that hosts an on-line encyclopedia to acquire relevant external information to annotate the selected terms.

When incorporating the user's configuration input and executed by the CPU 501, the annotation generator 510 can produce annotation for an ebook with information provided by a database in accordance with an embodiment of the present disclosure. The annotation generator 510 may comprise various functional modules that can be implemented in methods well known in the art, such as a search log file, term identification module, disambiguation module, link association module, a data mining interface, etc. The user configuration or input data to the annotation generator 510 may include an ebook for processing and information databases for example.

Although certain preferred embodiments and methods have been disclosed herein, it will be apparent from the foregoing disclosure to those skilled in the art that variations and modifications of such embodiments and methods may be made without departing from the spirit and scope of the invention. It is intended that the invention shall be limited only to the extent required by the appended claims and the rules and principles of applicable law.

What is claimed is:

1. A computer implemented method of automatically annotating an ebook, said method comprising:
accessing statistical information related to a collection of search query terms submitted by users concerning said ebook, said collection of search query terms submitted to one or more search engines;
automatically identifying a first plurality of annotation terms from said collection of search query terms based on said statistical information in accordance with a predetermined criterion;
automatically associating relevant external information with said first plurality of annotation terms; and
associating said relevant external information and said first plurality of annotations terms with said ebook.

2. A computer implemented method of claim 1, wherein said statistical information comprises a query frequency corresponding to each of said collection of search query terms relative to a number of users accessing said ebook, and wherein said predetermined criterion comprises a query frequency threshold corresponding to said ebook.

3. A computer implemented method of claim 1, wherein said collection of search query terms comprise search query terms submitted through a search field in an ebook graphical user interface (GUI) rendering said ebook.

4. A computer implemented method of claim 3, wherein said collection of search query terms further comprise a plurality of search query terms submitted through a web browser.

5. A computer implemented method of claim 1 further comprising:
accessing an information source site, said information source site comprising a plurality of webpages, each webpage associated with a subject title;
accessing content of said ebook; and
automatically identifying a second plurality of annotation terms of said ebook based on said content of said ebook and based on subject titles of said plurality of webpages.

6. A computer implemented method of claim 1, wherein said automatically associating comprises:
accessing an information source site, said information source site comprising a plurality of webpages, each webpage associated with a subject title;
matching each annotation term of said first plurality of annotation terms to a respective webpage of said information source site, wherein said respective webpage comprises said relevant external information of said annotation term; and
establishing a hyperlink between said annotation terms with said respective webpage of said information source site.

7. The computer implemented method of claim 1, wherein said matching comprises:
identifying multiple candidate webpages from said information source site based on relatedness between subject titles of said multiple candidate webpages and said annotation term; and
selecting said respective webpage from said multiple candidate webpages in accordance with a disambiguation process.

8. The computer implemented method of claim 1, wherein said ebook comprises each of said collection of search query terms, and wherein a search query term is selected from a group consisting of a word, a phrase, and/or a symbol.

9. A non-transitory computer-readable storage medium embodying instructions that, when executed by a processing device, cause the processing device to perform a method of automatically identifying key terms from an electronic text for annotation, said method comprising:
accessing a record of search events related to said electronic text, wherein said record comprises search terms submitted in said search events by users accessing said electronic text to one or more search engines, wherein said electronic text comprises said search terms; and
automatically identifying a first plurality of key terms for annotation from said search terms based on statistical information with respect to said search terms in accordance with a predetermined criterion, wherein said statistical information is derived from said record.

10. The non-transitory computer-readable storage medium of claim 9, wherein said statistical information represents a sum of occurrences of each of said search terms with respect to said electronic text, wherein said predetermined criterion corresponds to an occurrence threshold value defined for said electronic text.

11. The non-transitory computer-readable storage medium of claim 9, wherein said search terms comprise query terms submitted through an on-screen graphical user interface (GUI) configured to render said electronic text.

12. The non-transitory computer-readable storage medium of claim 10, wherein said search terms further comprise query terms submitted through web browsers independent of said GUI.

13. The non-transitory computer-readable storage medium of claim 9, wherein said method further comprises:
identifying an external digital document for each key term of said first plurality of key terms, wherein said external digital document comprises annotation information pertaining to said key term; and
establishing a hyperlink between said external digital document and said key term.

14. The non-transitory computer-readable storage medium of claim 13, wherein said identifying said external digital document comprises:
accessing a digital encyclopedia comprising a plurality of digital documents associated with respective subject titles;
identifying more than one digital documents for said key term based on subject titles thereof; and
selecting said external digital document from said more than one digital documents based on a disambiguating process.

15. The non-transitory computer-readable storage medium of claim 9, wherein said method further comprises:
accessing a digital encyclopedia comprising a plurality of digital documents that are associated with respective subject titles;
accessing content of said electronic text; and
identifying a second plurality of key terms based on a term frequency inverse document frequency (TF-IDF)-based analysis in accordance with a usage frequency and specificity of each of said second plurality of key terms.

16. The non-transitory computer-readable storage medium of claim 9, wherein said external digital document comprises content selected from a group consisting of text, audio, video, image, and a combination thereof.

17. A system comprising:
a processor;
a memory coupled to said processor and comprising instructions that, when executed by said processor, causes the processor to perform a method of automatically determining annotation terms from an ebook for annotation, said method comprising:
accessing statistical information related to a collection of search query terms submitted by users of said ebook to one or more search engines;
automatically identifying a first plurality of annotation terms from said collection of search query terms based on said statistical information in accordance with a predetermined criterion; and
associating said relevant external information and said first plurality of annotations terms with said ebook.

18. A system of claim 17, wherein said statistical information comprises a query frequency corresponding to each of said collection of search query terms relative to a number of users accessing said ebook, and wherein said predetermined criterion comprises a query frequency threshold corresponding to said ebook.

19. The system of claim 18, wherein said collection of search query terms comprise:
search query terms submitted through a search field in an on-screen ebook graphical user interface (GUI) configured to render said ebook; and
search query terms submitted through web browsers independent of said GUI.

20. The system of claim 17, wherein said automatically associating comprises:
accessing an information source site, said information source site comprising a plurality of webpages, each webpage associated with a subject title;
matching each annotation term of said first plurality of annotation terms to a respective webpage of said information source site, wherein said respective webpage comprises said external information of said annotation term; and
establishing hyperlinks between said first plurality of annotation terms with respective matching webpages of said information source site.
